(19) United States
(12) Patent Application Publication
(10) Pub. No.: US 2014/0046612 A1
(43) Pub. Date: Feb. 13, 2014

(54) Method for calibrating a sensor for turbidity measurement

(71) Applicant: Endress + Hauser Conducta Gesellschaft für Mess- und Regeltechnik mbH + Co. KG, Gerlingen (DE)

(72) Inventors: Edin Andelic, Stuttgart (DE); Carsten Gotz, Ettenheim (DE); Andreas Fedter, Stuttgart (DE)

(73) Assignee: Endress + Hauser Conducta Gesellschaft für Mess- und Regeltechnik mbH + Co. KG, Gerlingen (DE)

(21) Appl. No.: 13/959,115

(22) Filed: Aug. 5, 2013

(30) Foreign Application Priority Data
Aug. 7, 2012 (DE) 10 2012 107 214.0

(51) Int. Cl. G01F 25/00

(52) U.S. Cl. CPC G01F 25/00
USPC 702/100; 706/12

(57) ABSTRACT

A method for calibrating a sensor for measuring turbidity and/or solids content of a medium, wherein the sensor comprises at least one transmitting unit and at least two receiving units. The method comprises the steps of registering at least two measurement signals, which depend on the intensity of light scattered in the medium, wherein the light is sent from the transmitting unit and received by the receiving unit, abstracting the measurement signals to a feature vector, automatic selecting of a calibration model based on the feature vector, wherein the feature vector is transmitted to an earlier trained classifier and the classifier associates the calibration model with the feature vector, and calibrating the sensor with the automatically selected calibration model.

The invention relates to a method for calibrating a sensor for turbidity measurement.

Turbidity measurements in the sense of this invention are performed by means of a turbidity sensor especially in fresh- and industrial waters as well as in gases. Furthermore, this invention concerns measurements of similar process variables, such as solids content or sludge level. Measuring devices suitable for determining the corresponding process variables are manufactured and sold by the group of firms, Endress+Hauser, in a large number of variants, for example, under the designation “Turbimax CUS51D”.

Usually, the sensors are arranged in a sensor body, and the determining of the process variable is performed optically. In such case, electromagnetic waves of a certain wavelength are sent from at least one transmitting unit, scattered by the medium to be measured and received by a receiving unit. The wavelengths of the electromagnetic waves of the optical components lie typically in the near infrared range, for example, at 880 nm.

Applied as transmitter are, most often, narrowband radiators, e.g. a light-emitting diode (LED). In such case, the LED is used for producing light lying in a suitable wavelength range. Applied as receiver can be a corresponding photodiode, which produces from the received light a receiver signal, for example, a photocurrent or a photovoltage.

There are variants of turbidity sensors, which contain two LEDs and four photodiodes. Two photodiodes receive, in such case, the light sent from the LEDs and scattered by the medium at an angle of 90°; the two additional photodiodes receive the light scattered at an angle of 135°. In such case, a photodiode can receive light on a direct or indirect path. From this multiplicity of signals, one is able to select the signal suitable for the present characteristic of the medium, or a suitable signal combination (e.g. in the form of the four beam, alternating light signal combination). Also, there are variants with sensors, which work using the transmitted light method.

The sensor is able to measure the most varied of media, such as activated sludge, digested sludge, clear water, etc.

However, from this flexibility, there arises a problem in the case of calibrating. Different media require different mathematical calibration models. These different calibration models differ as regards the number of signals and as regards the mathematical model, with which one approximates the selected signal during the calibrating.

The selection of the corresponding calibration model is done manually by operating personnel in a software menu. In such case, there is the danger that mistakenly the incorrect calibration model is selected. Furthermore, it can happen that a calibration model is selected, which is actually provided as model for another medium, however, in spite of this, it is better suited for the current medium.

An object of the invention is to assure a reliable and correct selecting of the calibration model.

The object is achieved by a method for calibrating a sensor for measuring turbidity and/or the solids content of a medium, wherein the sensor comprises at least one transmitting unit and at least two receiving units, wherein the method comprises steps as follows:
registering at least two measurement signals, which depend on the intensity of light scattered in the medium,
   wherein the light is sent from the transmitting unit and received by the receiving unit,
abstracting the measurement signals to a feature vector,
automatic selecting of a calibration model based on the feature vector,
   wherein the feature vector is transmitted to an earlier trained classifier and the classifier associates the calibration model with the feature vector, and
calibrating the sensor with the automatically selected calibration model.

The automatic selecting of the calibration model means that mistakes are prevented and always the best, closest matching, calibration model for the corresponding medium is selected, so that always optimal calibration results are achieved.

Preferably, the classifier is trained by machine learning.

In an advantageous embodiment, the classifier is trained by at least one of the methods, naive Bayes classifier, neural network, support vector machine and/or by a rule-based method.

The said methods are established and enable optimal training of the classifier. A rule-based method forms, in such case, a relatively simple option, for, in such case, the classifier decides on a first calibration model, when the feature vector lies in a first region, on a second calibration model, when the feature vector lies in a second region, etc.

A special advantage is achieved, when the classifier is trained under laboratory conditions, wherein the training is performed at constant temperature, constant air pressure, with a well-defined amount of medium and with regular stirring of the medium.

It is preferred, in such case, that the classifier is retrained in ongoing measurement operation and, thus, continually improved on the basis of empirical values of the measurement operation. This can be done either automatically, and/or by having technicians make corresponding inputs to the classifier.

Profitably, the calibration model is selected by majority rule, wherein a plurality of measurements are performed and that calibration model selected for calibrating, which fits the most measurements. Thus, not the first calibration model is selected, but, instead, tha calibration model, which delivers the best results for the corresponding medium.

Preferably, the calibration is a multipoint calibration. By calibrating with different turbidity steps, the accuracy of the calibrating can be improved.

In an advantageous embodiment, the light is received by the first receiving unit at a first angle and by the second receiving unit at a second angle.

In a preferred further development, the feature vector is determined from eight features, wherein the sensor includes two transmission units and four receiving units.

The invention will now be explained in greater detail based on the appended drawing, the sole FIGURE of which shows as follows

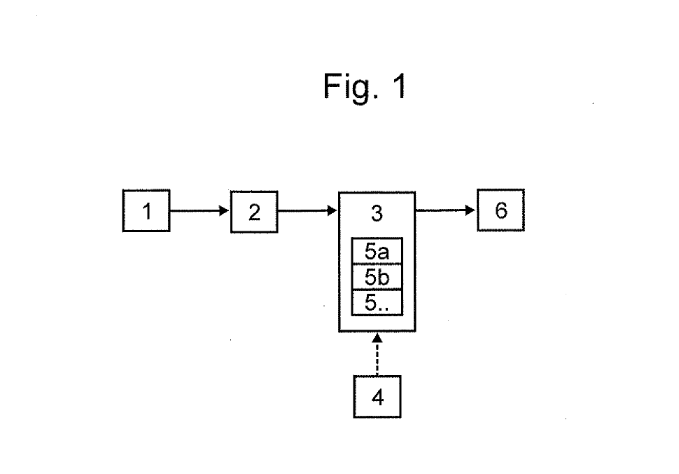

FIG. 1 flow diagram of the method of the invention.

The invention will be explained based on a turbidity measurement. The invention can, however, also be applied for measurements of similar process parameters, such as, for instance, sludge level or solids content. In the case of a turbidity sensor, there are typically two independently functioning sensor units with, in each case, one transmitter and two receivers. Preferably, the two receivers are used for receipt of light scattered at an angle of 90°, respectively 135°, to the beam direction of the transmitter. In the case of a turbidity sensor and low turbidity values, preferably the 90°-channel is used. At average and high turbidity values as well as for solids measurements, preferably the 135°-channel is used. Furthermore, the method of the invention can be applied for sensors, which measure with transmitted light. Decisive is only that more than a single receiver be used.

In the first step in block 1, measurement signals are registered. From the measurement signals, in block 2, a feature vector is formed. Thus, all measurement signals are contained in the feature vector. The feature vector is then transmitted to the classifier in block 3. The classifier selects based on the feature vector the best suitable calibration model 5a, 5b to 5 . . . When the calibration model has been selected, the sensor is then calibrated in block 6. The classifier 3 thus selects from a representative (see below) set of calibration models 5a, 5b, 5 . . . that calibration model, which best fits the feature vector.

The classifier 3 is trained earlier under laboratory conditions. Laboratory conditions in the sense of this invention include constant temperature, constant air pressure, a well-defined amount of medium and regular stirring of the medium, in order to keep turbidity constant. Typical values of these conditions include room temperature (22° C.), normal air pressure (1020 hPa), and a volume of about 20 l. In order to make the training as exact as possible, the volume is regularly stirred.

In the measuring under laboratory conditions, measurement signals are registered for at least one of the media, formazine, activated sludge, digested sludge, primary sludge, return sludge, kaolin and/or titanium dioxide. For training the classifier, it is necessary to have a database, which is as large as possible, in which values of the above described signals are stored for all possible media. It is to be heeded that the database is as representative as possible.

The classifier 3 can be trained by machine learning. Also, one of the methods, naive Bayes classifier, neural network and/or support vector machine can be used.

In the simplest case, also a rule-based method can be applied: if the feature vector 2 lies in a first region, then choose the calibration model 5a; if the feature vector 2 lies in a second region, then choose the calibration model 5b, etc.

After successful training under laboratory conditions, the classifier 3 is programmed permanently into the sensor or into the measurement transmitter. The classifier is, however, so embodied that it can relearn in ongoing measurement operation. This can happen either automatically, and/or technicians make corresponding inputs to the classifier.

In order to make the classifier reliable, decisions are made according to the majority principle. Thus, a large number of measurements are made and the first choice of the classifier is not immediately taken. Rather, for a certain period of time, the outputs of the classifier are stored and then that calibration model is selected, which occurs most frequently. Typical values for this are 10-15 measurements.

Typically, a multipoint calibration is performed, i.e. calibration is performed with different turbidity steps of the same medium, thus, for example, with “clear” water, “slightly turbid” water and “strongly turbid” water.

### LIST OF REFERENCE CHARACTERS

1 measurement signal under standard conditions

2 forming a feature vector

3 classifier

4 training

5a to 5 . . . calibration models

6 calibrating

1-9. (canceled)

10. A method for calibrating a sensor for measuring turbidity and/or solids content of a medium, wherein the sensor comprises at least one transmitting unit and at least two receiving units, wherein the method comprises steps of:
registering at least two measurement signals, which depend on the intensity of light scattered in the medium, wherein the light is sent from the transmitting unit and received by the receiving unit;
abstracting the measurement signals to a feature vector;
automatic selecting of a calibration model based on the feature vector, wherein the feature vector is transmitted to an earlier trained classifier and the classifier associates the calibration model with the feature vector; and
calibrating the sensor with the automatically selected calibration model.

11. The method as claimed in claim 10, wherein:
the classifier is trained by machine learning.

12. The method as claimed in claim 10, wherein:
the classifier is trained by at least one of the methods, naive Bayes classifier, neural network, support vector machine and/or by a rule-based method.

13. The method as claimed in claim 10, wherein:
the classifier is trained under laboratory conditions; and
training is performed at constant temperature, constant air pressure, with well-defined amount of medium and with regular stirring of the medium.

14. The method as claimed in claim 10, wherein:
the classifier is retrained in ongoing measurement operation.

15. The method as claimed in claim 10, wherein:
the calibration model is selected per majority rule; and
a plurality of measurements are performed and that calibration model selected for calibrating, which fits the most measurements.

16. The method as claimed in claim 10, wherein:
the calibrating is a multipoint calibration.

17. The method as claimed in claim 10, wherein:
the light is received by the first receiving unit at a first angle and by the second receiving unit at a second angle.

18. The method as claimed in claim 10, wherein:
the feature vector is determined from eight features, wherein the sensor includes two transmission units and four receiving units.
